(19) United States
(12) Patent Application Publication
(10) Pub. No.: US 2006/0058708 A1
(43) Pub. Date: Mar. 16, 2006

(54) Method and apparatus for ultrasonically increasing the transportation of therapeutic substances through tissue

(76) Inventors: Gill Heart, Dunwoody, GA (US); Gideon Tolkowsky, Herzliya (IL); Axel Brisken, Freemont, CA (US)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(21) Appl. No.: 11/140,845

(22) Filed: May 31, 2005

Related U.S. Application Data
(63) Continuation-in-part of application No. 10/746,311, filed on Dec. 24, 2003.

(51) Int. Cl. A61H 1/00

(52) U.S. Cl. 601/2

(57) ABSTRACT

The transportation of therapeutic substances through internal tissue is enhanced by surgically implanting an ultrasound transducer in immediate proximity to the target tissue and oriented to direct ultrasound having selected characteristics toward the target tissue. The parameters of frequency, mechanical index, pulses per cycle and pulse repetition frequency are selected within defined ranges to cause molecules to be transported at a rate and over a distance substantially greater than by natural diffusion.

### This application is a continuation-in-part and claims the benefit of application Ser. No. 10/746,311 filed Dec. 24, 2003.

### FIELD OF THE INVENTION

This invention relates to implantable ultrasound transducer devices and their use to enhance delivery of therapeutic substances to tissue by phonophoresis.

### BACKGROUND OF THE INVENTION

Most medicinal, pharmacological and other therapeutic substances are delivered systemically by oral, inhalation, injection or intravascular delivery. The substance ultimately reaches the vascular system and is transported to tissue and organs throughout the body. However, in cases where the targeted clinical disorder is localized, systemic methods may present some disadvantages. In order to create a sufficiently high concentration of the substance at the target site, systemic administration requires high dosage in comparison to the amount actually required at the target site. Exposure of untargeted organs or tissues may cause undesirable side effects. Moreover, in some disorders, such as those involving the neurological system, systemic delivery can fail due to the inability to deliver an adequate quantity of the substance across a biological barrier such as the blood-brain barrier.

The risks and difficulties inherent in systemic substance delivery have been long recognized, as evidenced by numerous examples of local substance delivery systems, such as the use of topically applied substances, local delivery of therapeutic substances internally of the body, as by implantable infusion pumps, to deliver therapeutic substances to a specific organ, and encapsulated therapeutic materials adapted to degrade and release the substance at the specific target site.

However, even when a substance is released locally at the treatment site, that, alone, cannot assure that the substance will diffuse adequately (i.e. (i) deep enough into the tissue; (ii) fast enough; and (iii) at sufficient concentrations) to perform the intended therapeutic function. In addition to release of the substance in the targeted region, the molecules of the substance must be distributed to, and then taken up by, the targeted tissue and cells. The natural biological diffusion process, which is passive and is based on concentration gradient, generally is relatively slow and in many cases may be inadequate to allow a sufficient quantity and concentration of the substances to reach the target tissue in time to achieve the intended therapeutic effect. Additionally, the rate at which the therapeutic substance is taken up by the cells also may limit the effectiveness of the treatment This is especially true with larger molecules (e.g. genes) which, under natural circumstances, will not be able to be taken up by the cell.

One such example is in treatment of Glioblastoma Multiforme, a particularly aggressive form of brain cancer. Treatment for glioblastoma involves immediate surgery to remove the tumor from the brain. However, because removal of excess tissue about the peripheral margins of the tumor may damage healthy brain cells, the surgeon may be reluctant to excise such peripheral tissue. Instead, upon removal of the tumor, the resulting cavity may be filled with a chemotherapeutic substance intended to diffuse into the peripheral tissue including cells and extracellular matrix, to treat cancer cells that may have diffused beyond the resected volume. One such chemotherapeutic substance is available commercially from Guilford Pharmaceuticals under the trade designation Gliadel wafers. A Gliadel wafer is configured as a small, dime-sized biodegradable biopolymer that delivers a chemotherapeutic drug (polifeprosan 20 with carmustine) directly to residual tumor cells after the tumor has been resected. Up to eight Gliadel wafers may be implanted along the walls and floor of the cavity left after the tumor has been resected. The wafers dissolve slowly, releasing the drug and bathing the surrounding cells. Transport of the chemotherapeutic agent relies on the body's natural diffusion mechanism, a passive process.

Although reliance on a passive, natural diffusion process of a locally placed substance, may be more effective than systemic treatment, it nevertheless presents a number of difficulties, particularly in treating conditions, such as some cancers, in which the rate of cell division or migration is high. In such conditions, the time for the therapeutic molecules to reach the cancer cells from their release site is critical. The molecules must reach the target cells, which may have migrated deep into the healthy tissue, in sufficient volume and concentration and at a rate that will enable them to attack the cells with a therapeutically effective dosage. Moreover, many therapeutic substances have short half-lives which adds to the criticality of transporting the therapeutic molecules to the target cells as quickly as possible.

Furthermore, a key advantage of local drug release is the ability to increase drug concentrations locally while avoiding side effects that usually are associated with systemic delivery. Higher drug concentrations at the treatment site enable improved drug penetration into the treated tissue. At the same time, upper limit of local drug concentration will be dictated by the allowed toxicity level. It is therefore worth noting that although advantageous over systemic delivery, the dependence of local drug release on the naturally occurring passive diffusion process falls short of addressing the need for deeper penetration of molecules into the tissue. It would therefore be desirable to enhance the rate and depth of transport of therapeutic substances through the treated tissue.

Although ultrasound has been described as useful in connection with the delivery of therapeutic agents, it is believed that the clinical application of ultrasound to enhance the delivery of therapeutic agents has been principally in connection with transdermal or corneal applications and has heavily relied on the mechanism of cavitation. In transdermal applications the ultrasound source is located outside of the body with the therapeutic substance being placed topically, as by application of a skin patch, to pass through the skin and into underlying tissue. In order to penetrate the barrier presented by the outermost layer of the skin, the stratus corneum, the applied ultrasound typically is selected to take advantage of the phenomenon of cavitation, a process by which minute microchannels can be formed temporarily in tissue. Cavitation is explained in “An Experimental and Theoretical Analysis of Ultrasound-Induced Permeabilization of Cell Membranes,” J. Sundaram, B R. Mellein, S. Mitragotri, Biophysical Journal Vol. 84, pp. 3087-3101, 2003; Miller et al in “A Review of in Vitro Bioeffects of Inertial Ultrasonic From a Mechanistic Perspective”, Ultrasound Med. Biol. 1996 22:1131-1154 and Leighton in “The Acoustic Bubble”. Academic Press, San Diego 1997 or by Lokhandwalla and Sturtevant in “Mechanical Haemolysis in Shock Wave Lithotripsy”. Phys. Med. Biol.2001 46:413-437.

Similarly, the cavitation phenomenon is used in the brain to temporarily open the blood-brain barrier and enable larger molecule to diffuse into the tissue. Blood vessels in the brain are lined with an additional thin layer of cells that acts as a barrier to molecules above certain size. Usually emitted transcranially, ultrasound is used to generate cavitation that, in turn, temporarily disrupts the blood-brain barrier allowing molecules of larger size to diffuse into the tissue.

Cavitation is considered to occur most easily and effectively within lower ultrasound frequency ranges, between about 20 kHz to about 250 kHz. At higher frequencies, the cavitation effect tends to be less dominant. It is believed to be generally accepted that in order for cavitation to be effective at higher frequency ranges (above about 250 kHz) the tissue should contain a high level of dissolved gas capable of forming bubbles or that the tissue should be artificially enriched with gas bubbles. Among the disadvantages of cavitations is that it tends to generate heat within the tissue. While that may be desired in some applications, as when tissue necrosis is an objective, limiting the temperature rise of healthy tissue and cells is preferred if they are to remain intact and functional.

It is believed that cavitation has been considered necessary to create microchannels in tissue through which the substance molecules can pass. Cavitation has been described as a phenomenon in which acoustic vibrations cause naturally available or artificially produced gas bubbles to oscillate or repeatedly expand and contract. The ultrasound energy causes the bubbles to increase in size. When the bubble grows to a size at which its spherical shape cannot be maintained, it bursts and collapses, rapidly accelerating fluid about the bubble to fill the void and developing a fluid microjet that causes a fine channel to be formed in tissue adjacent the bubble. The channels so formed in tissue are temporary and close by natural biological processes. Molecules of the drug or other substance can pass through the temporary channels.

It is believed that the practical utility of ultrasound-induced cavitation to form temporary channels through which therapeutic agents may pass has been limited, as a practical matter, to very short distances, for example, a distance sufficient to pass through the stratus corneum. The stratus corneum is composed of dead skin cells and varies in thickness at different locations on the body, typically having greatest thickness in highly calloused areas. By way of example, the stratus corneum in an uncalloused area of skin is measurable in microns and, for example, may be of the order of twenty microns in thickness.

The difficulties in applying ultrasound-induced cavitation to enhance drug delivery more deeply into tissue may be a consequence of several factors. In order to create the cavitation, the ultrasound energy delivered to the tissue must be sufficient to cause expansion of the bubbles not only in proximity to the ultrasound transducer but also over a distance corresponding to the full depth to which the transport of molecules is desired. While some tissues can be expected to contain some dissolved gases, the amount available may be insufficient to sustain, or even initiate, cavitation sufficient to generate the microchannels to enhance molecule transportation. Therefore, the development of sufficient cavitation in such tissue would seem to require preliminary enrichment of that tissue with sufficient bubbles capable of responding to the ultrasound energy. Further, assuming that large enough gas bubbles can be sustained long enough deep in the tissue to enable effective cavitation to occur, such process would be expected to result in a significant increase in tissue temperature consequently resulting in apoptosis.

Unlike the stratus corneum, in which the cavitation process may be facilitated by micro gas bubbles that may either reside in pores on the skin surface or be artificially introduced via a topical gel, other protective membranes of other internal organs as well as internally located tissue may not be readily susceptible of being enriched with microbubbles to sustain cavitation of those tissues. Perhaps for these reasons, although it has been recognized that it might be desirable to use ultrasound induced cavitation to facilitate drug transport to more deeply located internal tissues and organs, no clinically effective or practical system is believed to have been devised to achieve that objective.

In its application to brain tissue, therapeutic ultrasound is also used to elevate tissue temperature leading to tissue necrosis. Ultrasound energy is applied transcranially and is focused at the target site. Emission of very high energy level for a short time period will locally elevate tissue temperature leading to cell death. This process, referred to as high focused ultrasound (HIFU), is used to treat brain tumors while avoiding surgery. It is believed to have been generally thought that in order for ultrasound energy to reach greater tissue depths, it has been necessary to use a focused beam in order to compensate for the attenuation and beam dispersion of the ultrasonic energy by the tissue.

The clinical need to enhance the delivery and rate of transportation of therapeutic molecules to relatively deep locations has prompted the development of a technology for enhancing transportation of such molecules through tissue in the brain. This technology, referred to as “convection enhanced delivery” (CED) involves placement of a number of catheters in the brain tissue and delivering the therapeutic molecules through the catheters under hydraulic pressure. That technique is said to result in wider distribution of the molecules as compared with natural, unpressurized, diffusion. CED, however, is associated with several limitations, for example, the maximum allowed pressure per tissue volume, the maximum allowed pressurized volume per unit time, the catheter tip position sensitivity and a relatively long treatment time to achieve the desired distribution. Additionally, CED does not appear to be capable of effecting a drug distribution of more than ten millimeters from the catheter tip over several days. Finally, it appears that CED is capable of transporting drugs through the White matter only. Although that is a significant difference when compared with natural diffusion over a similar time period (of the order of 2-3 millimeters), the clinical need is for the therapeutic molecules to be distributed as far as twenty to thirty millimeters away from the release point.

Thus, although there is an important clinical need for enhanced transportation of molecules at greater rates and through increased distances with the ability to reach the target cells while still efficacious and in sufficient volumes and concentrations, and with the molecules being taken up by the target cells, that need has not yet been met.

### SUMMARY

The present invention is based, in part, on the recognition that the transportation of therapeutic molecules can be enhanced significantly by an implanted ultrasound device that does not necessarily rely on cavitation as a primary transporting force. Significantly the invention is based on the use of selected ranges of ultrasound energy parameters combined in a manner that will significantly enhance the depth to which therapeutic substances can be transported through tissue at a rate that enables a therapeutically effective dosage to be delivered to targeted cells and tissue. The parameters are selected to enhance substance transportation with a device of a size, configuration and energy output adapted for implantation within the tissue of interest.

The invention is adapted to be used internally by implanting an ultrasound transducer within or adjacent the targeted tissue to generate an ultrasound field directed toward that tissue with the therapeutic drug in the region of the target tissue and within the ultrasound field. The transducer is operated in accordance with the invention to obtain a high rate of molecule transport over substantially greater tissue depth than previously thought to be obtainable. The ultrasound energy is non-focused. Further, lower frequency range selection is such that resonant structures enable transducer implant-ability. Unlike external ultrasound probes in which device size is not of a major concern, in an implantable ultrasound device size is of critical importance. At the selected lower frequency range the cavitation effect is less of a dominant factor. At its upper range, frequency selection is such that thermal effects will be kept to a minimum. In particular, the desired frequency range is between about 500 kHz to about 1,500 kHz. Additionally, the ultrasound energy should be controlled to avoid adverse heating, preferably to maintain the temperature rise of the tissue to no more than about 2° C. The invention is practiced applying ultrasound energy with a mechanical index of between about 0.5 to about 3.0 and in a pulsed mode of about five to twenty cycles per cycle and a pulse repetition frequency of 100 Hz to about 10,000 kHz.

The bio-effects of ultrasonic energy typically are mechanical in nature (cavitational or pressure effects) or thermal in nature (heat due to absorption of energy or energy conversion). The American Institute for Ultrasound in Medicine (AIUM) and the National Electrical Manufacturers Association (NEMA) in “Standard for Real-Time Display of Thermal and Mechanical Indices on Diagnostic Ultrasound Equipment”, 1991, have together defined the terms “mechanical index” and “thermal index” for medical diagnostic ultrasound operating in the frequency range of 1 to 10 MHz, as follows.

Mechanical index, (hereafter “MI”), is defined as the peak rarefactional pressure (in MPa) at the point of effectivity (corrected for attenuation along the beam path) in the tissue divided by the square root of the frequency (in MHz), or
MI=P(MPa)/sqrt(f[MHz])
The tolerated range for diagnostic imaging equipment is up to an MI of 1.9. MI values over 1 to 2 represent acoustic levels which can cause mechanical bio-effects.

Among the objects of the invention is to enhance the transport of substances through tissue while maintaining the temperature rise of the tissue at a level that will not develop adverse thermal effects. In particular, it is preferred that the ultrasound energy be selected and controlled to avoid an average tissue temperature rise in the effected region that is greater than about two degrees Centigrade.

The present invention involves implantation of an ultrasonic transducer adapted to generate the ultrasound energy in a defined range of ultrasound frequencies, in a patient's body in close proximity both to the substance to be delivered and to the targeted tissue or organ intended to be treated by the substance. The transducer is arranged and oriented to direct the ultrasound toward the target. The therapeutic substance may be contained in a reservoir that may be incorporated into or may be separate from the implanted device. When separate, the reservoir may be implanted or may be located externally of the patient's body. Alternately, the substance is delivered from an outlet that is within or immediately adjacent the target tissue or organ. This is of particular importance in connection with therapeutic substances that have a relatively short half-life in which it is important to advance the substance into the target tissue and cells as quickly as possible.

The ultrasound device may be implanted simultaneously with the therapeutic substance or may be implanted strategically in a position such that the therapeutic substance may be delivered, separately, to the target region, at which time the ultrasound energy can be applied to the target tissue to enhance the transportation of the substance along the direction of the emitted ultrasound. The ultrasound transducer and system for delivering the therapeutic substance to a release point adjacent to or within the target tissue may employ a variety of systems. A number of such systems are disclosed in further detail in pending U.S. application Ser. No. 10/746,311 filed Dec. 24, 2003, the disclosure of those systems being incorporated herein by reference.

The practice of the invention also contemplates various methods, including surgical implantation of an ultrasound transducer in immediate proximity to the target tissue and oriented to direct ultrasound having selected characteristics toward the target tissue to enhance transportation from a location internally of the patient. By practice of the invention molecules may be phonophoretically transported at higher rates and over greater distances through tissue and cellular membranes by application of ultrasound energy at a frequency and energy level at which no substantial tissue necrosis occurs, and at which the ultrasound energy is applied from a location immediately adjacent the target tissue.

### THE DRAWINGS

The various aspects invention, their objects and advantages, will be appreciated more fully from the following description considered together the accompanying drawings wherein:

FIG. 1 is a somewhat diagrammatic sectional view of an implantable ultrasound transducer as may be used in the practice of the invention.

FIG. 2 is a diagrammatic illustration of an embodiment of the invention as it may be implanted within a surgically formed cavity in the brain of a patient for treatment of surrounding tissue about the remaining region of a resected tumor.

FIG. 3 is a diagrammatic sectional illustration of another embodiment of an ultrasound substance delivery device as may be used in the practice of the invention; and

FIG. 4 is a graph of experimental data comparing the transportation of mannitol molecules under varying ultrasound parameters with the natural diffusion rate of that substance;

FIG. 5 is a bar graph of data illustrating the relative rate of transport of mannitol molecules as a function of ultrasound frequency;

FIG. 6 is a bar graph of test data illustrating the effect on transportation of mannitol as a function of duty cycle at a constant frequency of about one MHz.

### ILLUSTRATIVE EMBODIMENTS

FIG. 1 illustrates an implantable ultrasound transducer assembly 10 as may be used in practicing the invention. The transducer assembly 10 includes a piezoelectric layer 12, a pair of conductive electrode layers 14, 16 overlying opposite faces of the piezoelectric layer 12 and defining the poles of the transducer, a pair of conductors 18, 20 connected to electrodes 14, 16, an acoustic matching layer 22 and a layer of biocompatible material 23 to encapsulate the components. The conductors 18, 20 are housed in an umbilical cord 25 formed from materials that provide electrical insulation and assure biocompatibility as will be familiar to those skilled in the art of implantable devices. The end of the cord 25 may be connected directly to a controllable power source or may have a connector 27 by which the conductors 18, 20 can be coupled to a source of electrical signals to activate the transducer. The device shown in FIG. 1 will emit ultrasound energy in opposite directions along the directions of transducer thickness as suggested by the arrows 11. While the implantable ultrasound transducer assembly 10 is depicted in a flat configuration in FIG. 1, it may be formed in any variety of shapes, such as spherical, among others, depending upon the needs of the particular application. The beam profile of the transducer may be varied by varying the shape of the radiative surface. The connector 27 may be implanted just beneath the skin or may be disposed externally. The connector may be coupled to a controllable source of signals, as by hard wired connectors. Other means for operatively associating the connector 27 with a source of operating signals may be provided. Additionally, an inductive circuit may be substituted for the connector by which signals may be induced, from a location external of the patient, to excite the transducer. The device as shown in FIG. 1 is an ultrasound-only device that may be placed independently of the mode of delivery of the therapeutic substance to the target tissue.

The thickness of the ceramic piezoelectric layer 12 typically may be the order of one half of a wave length and the matching layer may be of the order of one quarter of a wavelength and selected from a material having the correct acoustic impedance, as is familiar to those skilled in the art. The layer of biocompatible material 23 should have an acoustic impedance close to that of human tissue and may include material such as silicone rubber, polyethylene and polypropylene, among others. While it may be possible to use biocompatible materials having a higher acoustic impedance, that should be compensated for by appropriately varying the thickness of the acoustic impedance matching layer, as by making the layer thinner.

The dimensions of the implantable device should be such to enable it to be operated within the parameters of the invention as well as to facilitate its implantation in the intended target tissue. Preferably, the implantable device should be configured so that its maximum dimension is not greater than about two to three centimeters. For example, in the embodiment of the transducer illustrated in FIG. 1, the piezoelectric element 12 may have a diameter of the order of 1.5 centimeters and a thickness of about 1.5 millimeters for operation at one MHz.

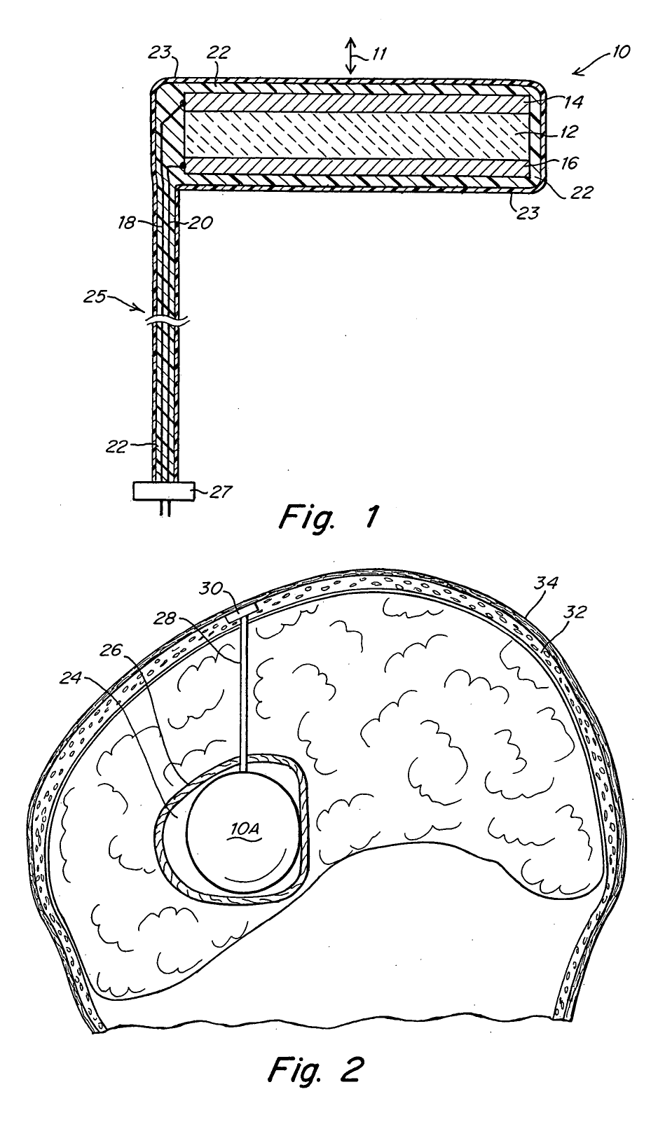

FIG. 2 illustrates, diagrammatically, one way by which the invention may be practiced, in the context of treatment for a brain tumor. By surgical removal of as much of the tumor as is considered appropriate, a cavity 24 will have been formed in the brain tissue. Because of the desirability of minimizing the loss of functioning brain cells, the neurosurgeon may be expected to leave some residual tumor 26. In one mode of practicing the invention, an implantable ultrasound transducer device 10A, shown in this illustration as spherical, is implanted in the cavity 24 to be in close proximity to the residual tumor 26 and surrounding tissue. The device should have a shape and ultrasound characteristics selected as suitable for the particular anatomy of the tumor or other type of treatable tissue and the resulting surgical configuration. The configuration and characteristics of the implanted device and transducer are selected so that it can be operated to generate and direct ultrasound toward the target tissue with intensity sufficient to penetrate the tissue to cause phonophorisis to a desired depth in the tissue. In the embodiment illustrated diagrammatically in FIG. 2, in which the device 10A is implanted within a cavity remaining after resection of a brain tumor, the device may be spherical so as to generate and direct ultrasound waves in an omnidirectional pattern and with an intensity sufficient to generate a phonophoretic effect to a desired radius. The radius should be sufficient to include all residual tumor 26 as well as some surrounding tissue as determined by the physician, in order to include cells that may have begun to migrate. The thickness of tissue to be treated may range from microns to centimeters. As described in further detail below, the device is configured and is operated within a range of parameters of frequency, mechanical index, pulse cycles and pulse repetition rate to achieve the enhanced substance transport of the invention.

By way of example, a spherical device as described above and adapted to operate within the range of parameters described below may have a diameter of the order of twenty millimeters and a wall thickness of the order to two millimeters at an operating frequency of one MHz.

The implantable device 10 may include an umbilical cord 28 by which electrical signals can be transmitted from a source to the internal piezoelectric transducer to generate and control operation of the device. The umbilical cord 28 may terminate in a portal 30 to provide electrical access to the cord 28. The portal may be placed subcutaneously on the patient's skull 32, as shown, or may be positioned externally of the body, with the cord 28 protruding through the skull and the scalp 34. It may be noted that a cavity surgically formed in brain tissue will tend to close about the implanted device. Additionally, voids that may initially exist in the cavity 24 between the brain tissue and the device will be filled by cerebro spinal fluid providing a void-free medium for ultrasound transmission.

The therapeutic substance that is to be applied may be placed within the cavity 24 by various means. In one approach, the therapeutic substance may be placed surgically and directly in the cavity 24 together with the ultrasound assembly 10. In other modes of operation, a reservoir containing the substance may be placed in the cavity and may be configured to dispense the therapeutic substance in a controlled manner. The device may comprise at least one implantable reservoir capable of controllably dispensing a desired quantity of a substance to the extracellular matrix or the targeted organ, tissue, or cell and an implantable transducer capable of generating ultrasound energy sufficient to produce the desired level of phonophoretic effect in the tissue at the target region. The reservoir may be configured to be replenishable with therapeutic substance, for example, by incorporating into the umbilical cord 28 a lumen adapted to deliver the therapeutic substance from the portal 30 to the reservoir. The reservoir also may be incorporated into the implantable assembly as an integral component, as described in application Ser. No. 10/746,311. In other embodiments, as when the target region is very small, the reservoir may be implanted in a location remote from the dispensing outlet and transducer, with an umbilical cord connecting the reservoir and dispensing outlet. As described in application Ser. No. 10/746,311 control electronics and power source may be implanted independently of the other components of the system.

The term “substance” as used herein is meant to include all manner of compositions for which local delivery could be employed. Such compositions may include, but are not limited to, chemotherapeutic compounds, genetic material, drugs, vitamins, amino acids, peptides and proteins, nucleic acids, DNA or RNA, anti-fungal agents, antibiotics, hormones, vitamins, anti-coagulation agents, antivirals, anti-inflammatories, local anesthetics, radioactive agents, organic and inorganic compounds, contrast agents, therapeutic agents with short-life cycle, bubble nuclei, micro-spheres (substance encapsulated), combinations thereof and the like. The substance may be in a fluid or fluent form, selected to have a viscosity appropriate to the flow and delivery requirements of the particular application, or may be in the form of surgically implantable biodegradable biopolymer or the like containing the therapeutic substance.

As used herein, the term “reservoir” is intended to include any device for containing or carrying a substance. For example, the reservoir may include a walled container adapted to hold a fluid or fluent substance such as saline, alcoholic saline or protein-buffered saline carrying the therapeutic substance. The reservoir may contain a substance contained in a hydrogel, where the hydrogel may be made of materials that are well known in the art such as synthetic polymers, including but not limited to, simethicone, silica gel, silica rubber, polyvinyl alcohol, polyethylene glycol, polymethacrylate, polypropyleneglycol, copolymers and derivatives with and without cross-linking and other polymers such as alginic acid, pectins, albumin, collagen, and other materials suitable for forming a gel to contain the desired substance. Similarly, the reservoir may be in the form of a synthetic, biodegradable, solid polymer such as PCl, (20:80) PLCl, PGLCl, PLA, or combinations thereof containing the therapeutic substance.

In most applications of the invention, it will be desirable to deliver the therapeutic substance directly to the immediate region of the target site, either by implanting the therapeutic substance at the site or delivering it through a delivery system directly to the site. This is particularly important with those substances that may have a relatively short half-life, possibly of the order of several minutes, and must be transported to and taken up by the tissue very quickly.

The piezoelectric component of the transducers may be comprised of any suitable piezoelectric material such as those based on polymers, ceramics, and micromachined silicon wafers, as described by Van Lintell, et al., Sensors and Actuators (1988) 15(2):153-167. PZT is a presently preferred ceramic and, in accordance with the present invention should be fabricated to generate ultrasound having characteristics to enhance molecular transport. In accordance with the present invention, the rate and depth of transport may be significantly enhanced by the use of a transducer that will generate ultrasound in a frequency range that in its lower extent will be sufficiently high to avoid the tendency to induce a high degree of cavitation and in its upper extent that will avoid a tendency to generate adverse thermal effects in the tissue and within a frequency range which allows the device to be sized so that the resonant structures can be implanted. In particular, in accordance with the present invention, the frequency of the ultrasound should be within the range of about 500 kHz to about 1,500 kHz. The ultrasound emitting material should have a surface area large enough to enable emission of energy within that frequency range, and having a mechanical index of about 0.5 to about 3.0 and operable in pulses having about 5 to about 20 cycles per pulse and a pulse repetition frequency of about 100 Hz to about 10,000 Hz. Among the materials of the polymeric type are included PVDF (polyvinylidene fluorides) and PVDF-TRFE (polyvinylidene fluoridetrifluoroethylene) as described by Chan, H. L. W., et al. (2000) IEE Transacts: On Dielectrics and Electrical Insulation, vol. 7(2) pp.204-207. Suitable ceramics include lead zirconate-titanate (PZT) with or without dopants, lead titanate (PT) and lead metaniobate (PMN). Also, for transducers employing planar structures, suitable materials may include lithium niobate, lead based single piezoelectric crystals, or magnetostrictive materials such as Terfenol.

The ultrasound energy that is emitted from the device is at an energy level that will not substantially adversely affect the viability of the target tissue and cellular elements. Therefore, the characteristics of the emitted ultrasound energy are such that no substantial tissue necrosis or other irreversible effect will occur. Undesirable thermal ultrasound bio effects are generally avoided by controlling the temporal average intensity of the ultrasound. The energy levels also may be controlled by operating the control module to appropriately vary the duty cycle and other control parameters. The present invention may be contrasted with conventional diagnostic ultrasound techniques in which the ultrasound is focused and where the frequency ranges are well above the proposed values. The present invention is further contrasted with conventional physical therapeutic ultrasound techniques in which the ultrasound is focused and adapted to elevate tissue temperatures and is within a frequency range outside that of the present invention.

The invention may be practiced in varying configurations. The form of the device may be dictated, in part, by the requirements and characteristics of the particular implantation site. FIG. 3 illustrates, somewhat diagrammatically in cross section, one such alternative configuration in which the target tissue 120 has dimensions, a shape or is positioned such that a non-spherical ultrasound field would be more appropriate. In this embodiment, the device 121 has a transducer 122 that is flat, having a piezoelectric layer 124 with conductive electrode layers 126, 128 formed on opposite sides of the piezoelectric layer 124. The device may include an annular frame 129 that defines the periphery of the device and provides support for other internally contained components. An ultrasound matching layer 130 is provided on the ultrasound emission face of the transducer 122. The innermost electrode layer 126 should be covered with a layer 131 of material that is inert to the selected therapeutic substance. The inert layer 131 also may define one surface of a reservoir 36B. There may be instances in which it would be desirable to block rearward transmission, for example, to protect the substance molecules from long exposures to ultrasound energy. In such cases layer 131 can be fabricated to form an anti-transmission layer to block such exposure. The reservoir may be enclosed by a reservoir wall 132. In this embodiment passageways 135 for transporting the fluid from the reservoir to the tissue would need to be lined with a suitable polymer material, to prevent the fluid from contacting the electrodes of the transducer. The back side of the piezoelectric ceramic also may comprise an anti-transmission layer (not shown) to reflect most of the ultrasound energy radiated in the rearward direction to the forward direction, thus avoiding potentially destructive interfering acoustic reflections from components placed behind the ceramic. The device may include a chamber 133 adapted to house a power source 40 and a control module 42 as described in application Ser. No. 10/746,311. Passageways, shown diagrammatically at 125 and 127 may be formed through the frame 129 for passage of electrical wires and for enabling refilling of the reservoir from an implanted or an external source. Suitable electrical conductors may extend through the housing as through the ring 129, to couple the device with computer controls.

Also as shown in FIG. 3, the device may be provided with an attachment ring 134 by which sutures 136 can be employed to secure the device in place. The device also may include a temperature sensor 142 coupled to appropriate electronics, as by a wire 143, to monitor the tissue temperature.

The devices may be constructed and controlled to provide some limited range of emitted ultrasound frequencies. By the appropriate implementation of one or more front surface impedance matching layers, the bandwidth of the device may be broadened substantially. Techniques for creating one or more impedance matching layers are well known to those skilled in the art. Combinations may be selected to allow up to 50 to 100% bandwidth about the center frequency. Thus, the signal generator may be adjusted to cause device operation at any frequency within the achieved band width.

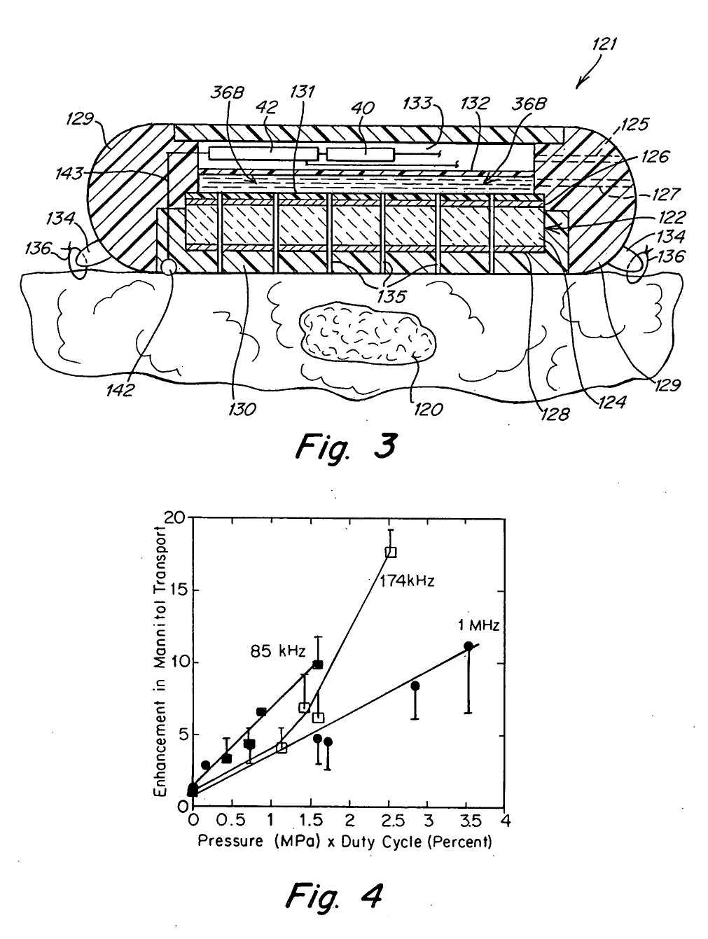

FIG. 4 is a graph of data from in vitro tests conducted to assess the effect of varying ultrasound parameters on the transportation rate through tissue. Testing was conducted with a modified Franz-type cell adapted to hold a three-millimeter thick section of fresh porcine brain tissue supported between a donor chamber and a receiver chamber. An ultrasound transducer was associated with the donor chamber to direct ultrasound energy at the tissue sample. The donor chamber, between the transducer and the porcine sample was filled with non-degassed saline and a known concentration of radio-labeled mannitol molecules and the receiver chamber was filled with saline. The ultrasound transducer was operated at frequencies of 85 kHz, 174 kHz and 1 MHz. For each frequency, the ultrasound energy was varied and was calculated as the product of acoustic pressure (MPa) and duty cycle (percent). The rate at which the mannitol was transported through the three-millimeter specimen of brain tissue under the influence of varied ultrasound parameters was compared with a control, i.e. no ultrasound enhancement, and corresponds to the natural diffusion rate of the mannitol through that thickness of porcine brain tissue. The concentration of mannitol in the receiver chamber was measured at regular intervals over the course of four hours to determine the rate of natural diffusion. That was compared with the concentration in the receiver chamber after application of ultrasound energy at various frequencies and duty cycles at identical time intervals thus providing data of the relative ranges at which the mannitol molecules were transported through the three-millimeter samples. The pressure (amplitude) was maintained constant while the duty cycle was varied. FIG. 4 indicates that in the tested frequency ranges the number of molecules of mannitol passing through the three-millimeter brain tissue was between ten and eighteen times that of the rate of natural diffusion. By comparison, at the same level of total emitted power (1.5 units) a frequency of 1 MHz enhanced the transportation rate by a factor of five. At one MHz, the level of cavitation, if any, is very low, demonstrating that cavitation is not necessary in order to enhance the transportation rate. Additionally, FIG. 4 data indicates that by increasing the duty cycle and pressure so that the total emitted power was approximately 3.5 units, the transportation rate was increased by approximately a factor of twelve.

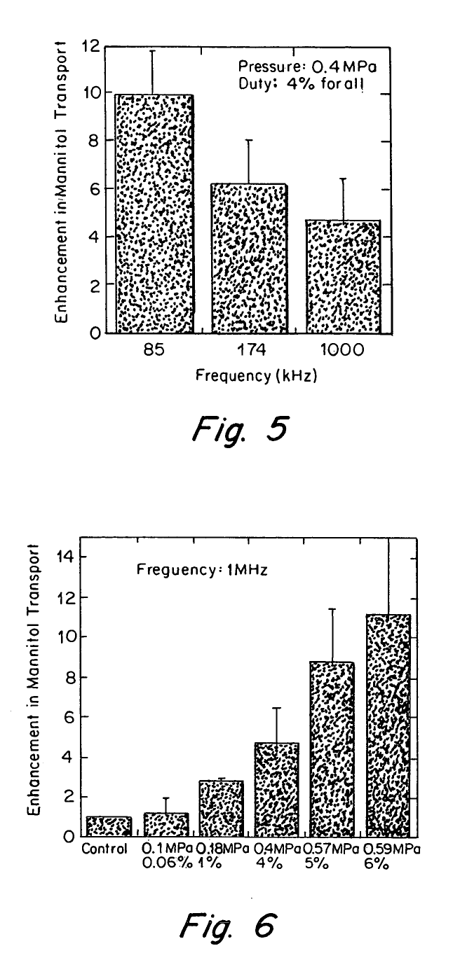

FIG. 5 illustrates relative transportation rates as a function of frequency. By maintaining the pressure and duty rate constant (0.4 MPa and 4%) and considering only variations in frequency (85 kHz, 174 kHz and 1,000 kHz), the transportation rate was seen to decrease as the frequency increased.

FIG. 6 shows the relationship between duty cycle and transportation at one MHz. Transportation of the mannitol molecules through three millimeters of porcine brain tissue was enhanced by a factor of five at a duty cycle of four percent and pressure of 0.4 MPa. At the same operational frequency, an increase of two percent in duty cycle to six percent and pressure by 0.2 MPa resulted in a factor of eleven times enhancement of transportation.

We claim:

1. A method for enhancing the local delivery of therapeutic molecules to internal target tissue of a patient comprising:
delivering the molecules to the region of the target tissue;
generating an unfocused ultrasound field from a source located within the internal tissue and in the immediate vicinity of the target tissue to direct emitted ultrasound energy toward the target tissue, the ultrasound being characterized by a frequency in the range of about 500 kHz to about 1,500 kHz, a mechanical index of between about 0.5 and about 3.0, the ultrasound being pulsed and having between about 5 to about 20 cycles per pulse and a pulse repetition frequency of between about 100 to about 10,000 Hz;
the characteristics of the ultrasound energy being selected to enhance the transport of therapeutic molecules through the tissue under the influence of ultrasound energy at a rate substantially greater than the natural rate of transportation through the tissue, and in a sufficient number and concentration to have a therapeutic effect on the target tissue.

2. A method as defined in claim 1 wherein the thermal effect of the ultrasound is such that the target tissue is not raised more than about 2° C.

3. A method as defined in claim 1 wherein the therapeutic molecules are transported over a distance of at least twenty millimeters.

4. A method as defined in claim 1 wherein the therapeutic molecules are transported over a distance of at least thirty millimeters.

5. A method as defined in claim 1 wherein the internal target tissue comprises brain tissue.

6. A method as defined in claim 1 wherein the tissue comprises soft tissue.

7. An apparatus for enhancing the local delivery of therapeutic molecules to internal target tissue of a patient comprising:
an implantable ultrasound transducer having an ultrasound emitting material with a surface area of sufficient dimensions to enable emission of energy having a frequency in the range of about 500 kHz to about 1,500 kHz, a mechanical index of about 0.5 to about 3.0, a thermal index no greater than about 2.0 with the pulses of ultrasound energy having between about 5 to about 20 cycles per pulse and a pulse repetition frequency of between 100 to about 10,000 Hz;
the ultrasound transducer being adapted to be implanted in immediate proximity to the target tissue.

8. An apparatus as defined in claim 7 further comprising the transducer having a maximum cross-sectional dimension not greater than about three centimeters.

9. An apparatus as defined in claim 7 wherein the transducer has a maximum cross-sectional dimension no greater than about two centimeters.
